(19) United States
(12) Patent Application Publication
(10) Pub. No.: US 2016/0241287 A1
(43) Pub. Date: Aug. 18, 2016

(54) SIM CARD APPLICATOR AND RELATED METHOD OF OPERATION

(71) Applicant: KNOWROAMING LTD, North York (CA)

(72) Inventor: Mathew STEIN, North York, ON (CA)

(73) Assignee: KNOWROAMING LTD., North York, ON (CA)

(21) Appl. No.: 15/021,869

(22) PCT Filed: Sep. 12, 2014
(86) PCT No.: PCT/IB2014/064462

§ 371 Date: Mar. 14, 2016

Related U.S. Application Data
(60) Provisional application No. 61/877,595, filed on Sep. 13, 2013.
(60) Provisional application No. 61/881,708, filed on Sep. 24, 2013.

(51) Int. Cl. H04B 1/3818

(52) U.S. Cl. CPC H04B 1/3818

(57) ABSTRACT

A SIM card applicator to enable a communications processing overlay to be attached to a SIM card is provided, the SIM card comprising a plurality of SIM card pads. The overlay comprises a communications processing portion and overlay pads that allow for the communications processing portion to send/receive information to/from the SIM card, once attached. The applicator comprises a holder to releasably hold the overlay in place; and a SIM receiving body to receive the SIM card, the holder and the SIM receiving body being arranged to correctly align and secure the communications processing portion of the overlay and the SIM card pads of the SIM card, wherein the overlay can be removed or separated from the holder, thereby resulting in the communications processing portion of the overlay being correctly aligned and secured to the SIM card pads, so as to define a modified SIM card for use in a mobile device.

This invention relates to the subject matter contained in co-pending U.S. application No. 61/760,905, which is incorporated herein by reference. In broad terms, U.S. Ser. No. 61/760,905 discloses a system and method for authenticating a mobile device on an alternate communications network that has been selected to provide a user of the mobile device with better calling and/or data rates. In one embodiment, a SIM card overlay in the form of a PCB device is used to achieve the required authentication within the various mobile networks.

As described in U.S. Ser. No. 61/760,905, the overlay comprises:
1) A communications processor;
2) A PCB (flexible or otherwise) upon which the communications processor is mounted and wires are routed; and
3) Pads that allow for the communications processor to send/receive information to/from the mobile device's SIM card.

### FIELD OF THE INVENTION

This invention relates to a SIM card applicator and to a related method of operating this applicator.

### BACKGROUND OF THE INVENTION

The overlay needs to be accurately attached to the device's SIM card (and in particular to the pads of the SIM card), with this typically needing to be done by the end user. It is thus an aim of the present invention to provide a SIM card applicator, and related method, to easily and accurately achieve this.

### SUMMARY OF THE INVENTION

According to a first aspect of the invention there is provided a SIM card applicator to enable a communications processing overlay to be attached to a SIM card, the SIM card comprising a plurality of SIM card pads, the overlay comprising a communications processing portion and overlay pads that allow for the communications processing portion to send/receive information to/from the SIM card, once attached, the applicator comprising:
a holder to releasably hold the overlay in place; and
a SIM receiving body to receive the SIM card, the holder and the SIM receiving body being arranged to correctly align and secure the communications processing portion of the overlay and the SIM card pads of the SIM card,
   wherein the overlay can be removed or separated from the holder, thereby resulting in the communications processing portion of the overlay being correctly aligned and secured to the SIM card pads, so as to define a modified SIM card for use in a mobile device.

In an embodiment, the SIM receiving body comprises a credit card style holder with a cutout for accommodating the SIM card, with the cutout being aligned with the overlay. Advantageously, the cutout is SIM card-sized.

In an embodiment, the applicator may include an adaptor that can be placed within the cutout, the adaptor being arranged to accommodate a variety of different sizes of SIM cards.

In an embodiment, the holder comprises an adhesive protective film to which the overlay is releasably secured, the film also being releasably securable to a first side of the SIM receiving body.

In an embodiment, the applicator comprises a second adhesive protective film that is releasably securable to a second side of the SIM receiving body, so as to cover the overlay on the other side of the SIM receiving body. The overlay has adhesive applied to it, with the purpose of the second adhesive protective film being to shield the overlay from accidental damage and to prevent the adhesive on the overlay from drying out.

In an embodiment, the overlay comprises a carrier portion that surrounds the communications processing portion, with the applicator being arranged to remove or separate the communications processing portion of the overlay from the surrounding carrier portion, thereby resulting in the communications processing portion of the overlay being correctly aligned and secured to the SIM card pads, so as to define a modified SIM card for use in a mobile device.

In an embodiment, the applicator includes a cutter element that can be operated to cut out the communications processing portion of the overlay from the surrounding carrier portion.

In one version, the applicator comprises a base plate to define the SIM receiving body, the base plate defining an aperture to accommodate the SIM card.

In this first version, the applicator comprises a frame that is pivotally movable relative to the base plate, the frame defining a window for accommodating the overlay, the window and the aperture in the base plate being in alignment when the base plate and the frame are pivotally moved towards each other, so as to correctly align the communications processing portion of the overlay with the SIM card pads.

In an embodiment of this first version, the frame comprises securing means, such as an adhesive film, for securing, and correctly positioning, the overlay to the frame, and for securing the overlay to the SIM card once the base plate and the frame have been pivotally moved towards each other and pressed together.

In an embodiment of this first version, the cutter element includes a cutting formation that is shaped to correspond to the interface between the communications processing portion and the surrounding carrier portion, to facilitate the separation of the communications processing portion from the surrounding carrier portion.

In an embodiment, the interface between the communications processing portion and the surrounding carrier portion is weakened (perforated, in some cases) to further facilitate the separation of the communications processing portion from the surrounding carrier portion.

In an embodiment, the surrounding carrier portion may comprise a tape to which the communications processing portion is releasably secured.

In an embodiment of this first version, the cutter element is pivotally movable relative to the frame and the base plate; alternatively, the cutter element is a separate component, not attached to the frame and base plate.

In an alternate version, a frame arrangement is provided that integrally defines both the holder and the SIM receiving body, the frame arrangement defining a central aperture.

In this alternate version, the applicator comprises a jig body having a slot to receive the frame arrangement, the jig body defining a central aperture to register with the central aperture of the frame arrangement when the frame arrangement is inserted into the jig body.

In an embodiment, the overlay is fitted with a removable covering film, which upon removal, ensures the securing, and correct alignment, of the SIM card to the overlay.

In an embodiment, the frame arrangement comprises a pair of plastic frame members, each defining the central aperture, the frame members having securing members to secure the frame members together and to sandwich the overlay and its associated removable covering film between the frame members.

In an embodiment, the frame arrangement and the jig body include complementary guiding formations to facilitate the insertion of the frame arrangement into the slot of the jig body.

In an embodiment, the cutter element includes a cutting formation that is shaped to correspond to a perforated interface between the communications processing portion and the surrounding carrier portion, to facilitate the separation of the communications processing portion from the surrounding carrier portion.

The cutter element in this version is thus a separate component, which can be manually moved so that the cutting formation is punched through the aligned apertures in the frame arrangement and the jig body.

According to a second aspect of the invention there is provided a method of applying a communications processing overlay to a SIM card, the SIM card comprising a plurality of SIM card pads and the overlay comprising a communications processing portion and overlay pads, the method comprising:
providing a holder to which the overlay is releasably secured;
aligning the overlay within a cutout defined in a SIM receiving body, the overlay having an adhesive on an exposed face;
locating the SIM card within the cutout;
firmly bonding the SIM card to the communications processing portion of the overlay; and
removing the bonded SIM card and overlay from the holder, thereby resulting in the communications processing portion of the overlay being correctly aligned and secured to the SIM card pads, so as to define a modified SIM card for use in a mobile device.

In an embodiment, the method comprises an initial step of removing a second protective film fitted to the other side of the SIM receiving body, so as to expose the adhesive, exposed face of the overlay.

According to a third aspect of the invention there is provided a method of applying a communications processing overlay to a SIM card, the SIM card comprising a plurality of SIM card pads and the overlay comprising a communications processing portion and a surrounding carrier portion, the method comprising:
aligning and securing the communications processing portion of the overlay and the SIM card pads of the SIM card; and
removing the communications processing portion of the overlay from the surrounding carrier portion, thereby resulting in the communications processing portion of the overlay being correctly aligned and secured to the SIM card pads, so as to define a modified SIM card for use in a mobile device.

According to a fourth aspect of the invention there is provided a frame arrangement for a SIM card applicator to enable a communications processing overlay to be attached to a SIM card, the overlay comprising a communications processing portion and a surrounding carrier portion, the frame arrangement comprising a frame body defining a central aperture, the overlay being positioned within the frame body, with the SIM card being housed within the central aperture of the frame body, the frame arrangement thus accommodating and correctly aligning the overlay and the SIM card.

In an embodiment, the frame body comprises:
a pair of plastic frame members, each defining the central aperture, the overlay being positioned between the pair of plastic frame members; and
securing members to secure the frame members together, so as to sandwich the overlay between the frame members, with the SIM card being housed within the central apertures of one of the frame members.

In an embodiment, the overlay is fitted with a removable covering film, which upon removal, ensures the securing, and correct alignment, of the SIM card to the overlay within the frame arrangement.

### BRIEF DESCRIPTION OF THE DRAWINGS

FIG. 1 shows an exploded, perspective view of a SIM card applicator, according to an embodiment of the present invention.

FIGS. 2, 3 and 4 show first, second and third perspective views of a SIM card applicator, respectively, according to a first embodiment of the present invention;

FIGS. 5 and 6 show first and second perspective views of a SIM card applicator according to a second embodiment of the present invention;

FIG. 7 shows an exploded perspective view of a SIM card applicator, according to a third embodiment of the present invention;

FIG. 8 shows an exploded perspective view of a frame arrangement for use in the SIM card applicator shown in FIG. 7;

FIGS. 9 and 10 show first and second perspective views of the frame arrangement shown in FIG. 8, respectively, in an assembled form, ready to securely receive a SIM card; and

FIG. 11 shows an exploded perspective view of the SIM card applicator in FIG. 7, in use.

### DESCRIPTION OF PREFERRED EMBODIMENTS

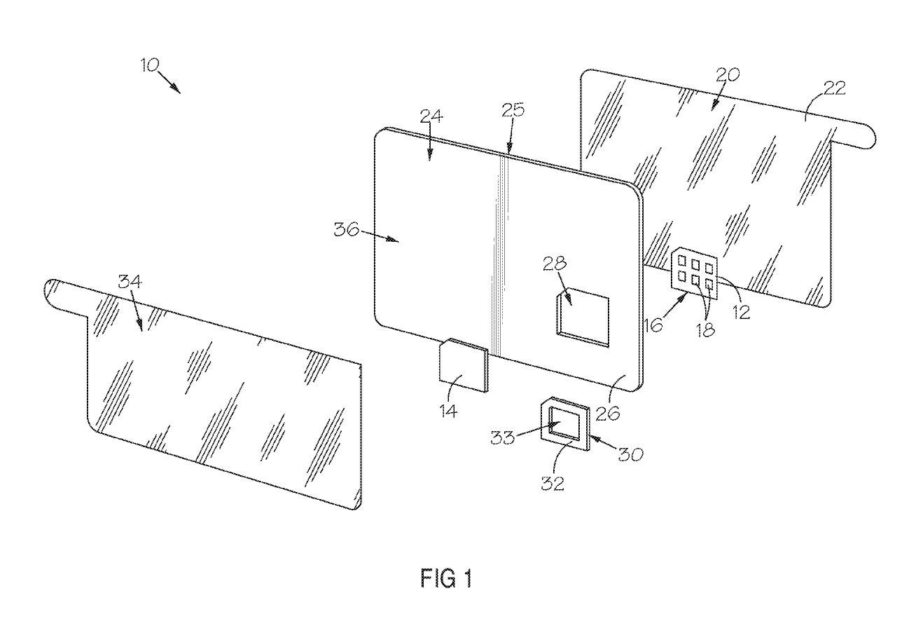

Referring first to FIG. 1, a SIM card applicator 10 is provided to enable a communications processing overlay 12 to be attached to a SIM card 14. The SIM card 14 comprises a plurality of SIM card pads (not shown, as they are on the other side of the SIM card). The overlay 12 comprises a communications processing portion 16 and overlay pads 18 that allow for the communications processing portion 16 to send/receive information to/from the SIM card 14, once attached.

The applicator 10 comprises a holder 20 to releasably hold the overlay 12 in place. In an embodiment, the holder 20 comprises an adhesive, clear protective film 22 to which the overlay 12 is releasably secured. In particular, the strength of the adhesive between the overlay 12 and the film 22 is such that the overlay 12 may be separated relatively easily from the film 22, as will be explained in more detail further below.

The applicator 10 further comprises a SIM receiving body 24 to receive and accommodate the SIM card 14, the holder 20 and the SIM receiving body 24 being arranged to correctly align and secure the communications processing portion of the overlay 12 (and in particular the overlay pads 18 of the overlay 12) and the SIM card pads of the SIM card 14. The film 22 is also releasably securable to a first side 25 of the SIM receiving body 24, so as to, initially at least, define an integral body.

In broad terms, therefore, the overlay 12 can be removed or separated from the holder 20, thereby resulting in the communications processing portion of the overlay 12 (and in particular the overlay pads 18 of the overlay 12) being correctly aligned and secured to the SIM card pads, so as to define a modified SIM card for use in a mobile device.

In an embodiment, the SIM receiving body 24 comprises a credit card style holder 26 with a SIM card-sized cutout 28 for accommodating the SIM card 14, with the cutout 28 being aligned with the overlay 12.

The applicator may include an adaptor or clip 30 that can be placed within the cutout 28, the adaptor 30 being arranged to accommodate a variety of different (i.e. smaller) sizes of SIM cards. Irrespective of the SIM card size, the pads on the SIM card 14 are uniform, with the pads 18 on the overlay 12 being arranged accordingly. The adaptor (or adaptors) may thus simply take the form of a frame 32 that fits snugly within the cutout 28, with the frame defining a smaller internal aperture 33 for receiving the (smaller) SIM card, if required/necessary.

In an embodiment, the applicator 10 comprises a second adhesive protective film 34 that is releasably securable to a second side 36 of the SIM receiving body 24, so as to cover the overlay 12 on the other side of the SIM receiving body 24. The overlay 12 has adhesive applied to it, with the purpose of the second adhesive protective film 34 being to shield the overlay 12 from accidental damage and to prevent the adhesive on the overlay 12 from drying out.

Thus, in use, a user first removes the second adhesive protective film 34 from the second side 36 of the SIM receiving body 24. This exposes the cutout 28, behind which the overlay 12 would be positioned and aligned with the cutout 28. The user then places their SIM card 14 within the cutout 28. If required i.e. if the SIM card 14 is smaller than the cutout, the user may use the adaptor 30 to securely fit the SIM card 14 within the cutout 28. The user then firmly presses the SIM card 14 against the overlay 12, with the adhesive on the overlay 12 thus ensuring that the SIM card 14 is firmly bonded to the overlay 12. The protective film 22 on the first side 25 of the SIM receiving body 24 is then removed from the SIM receiving body 24, with the bonded overlay-SIM card then being removed from the protective film 22, for subsequent use in the user's mobile device.

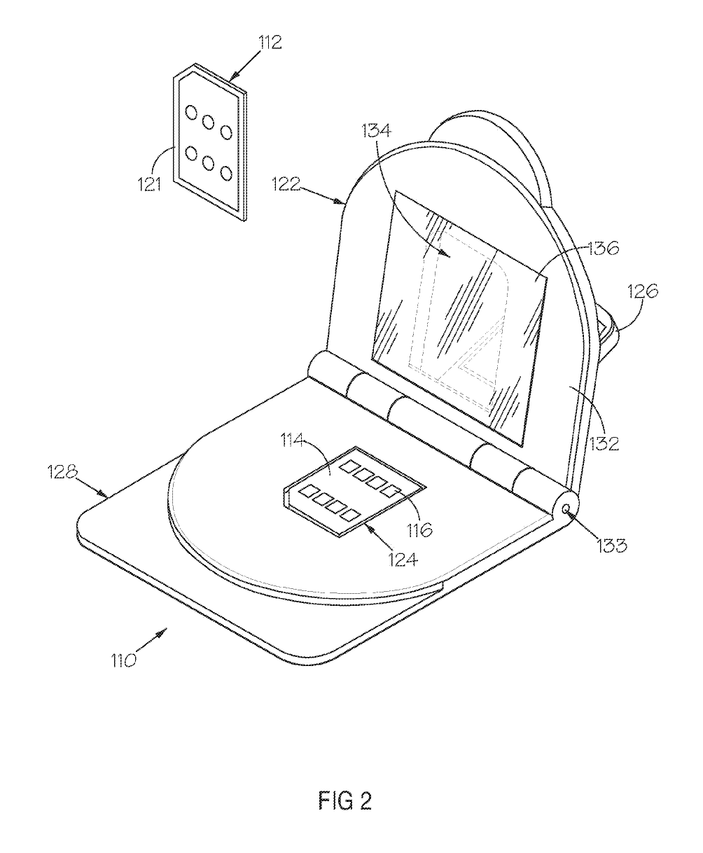

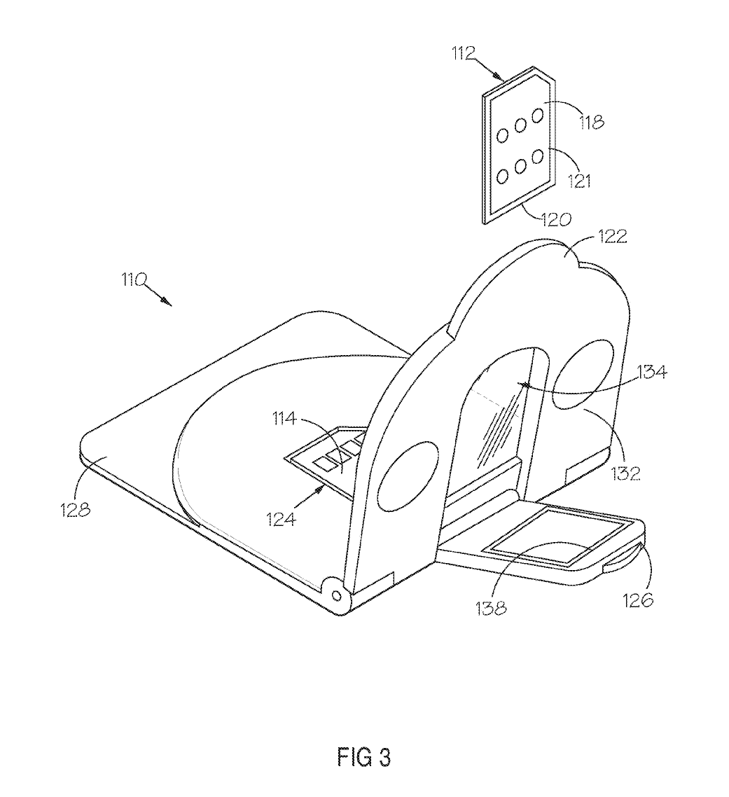

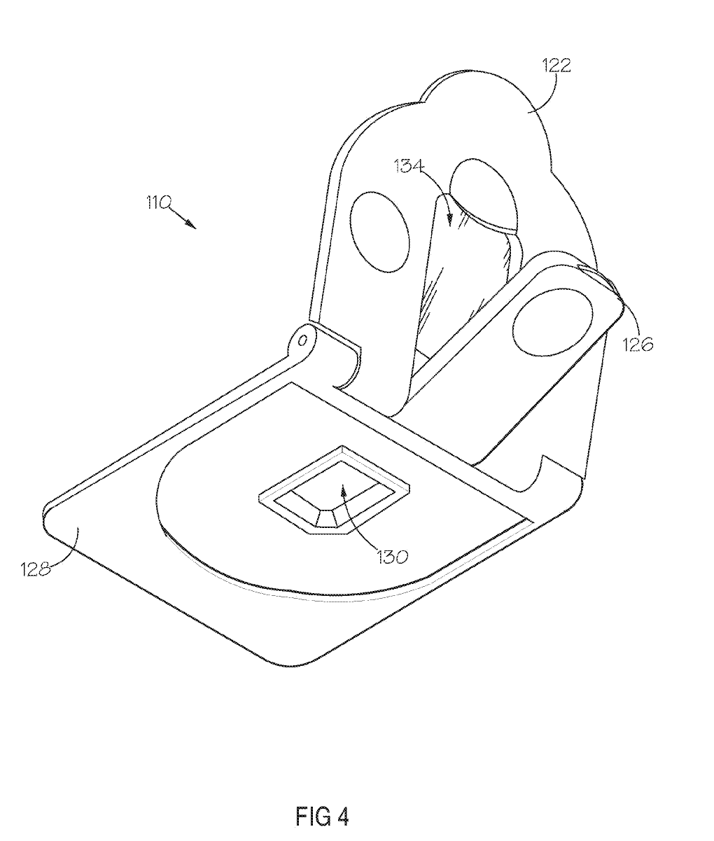

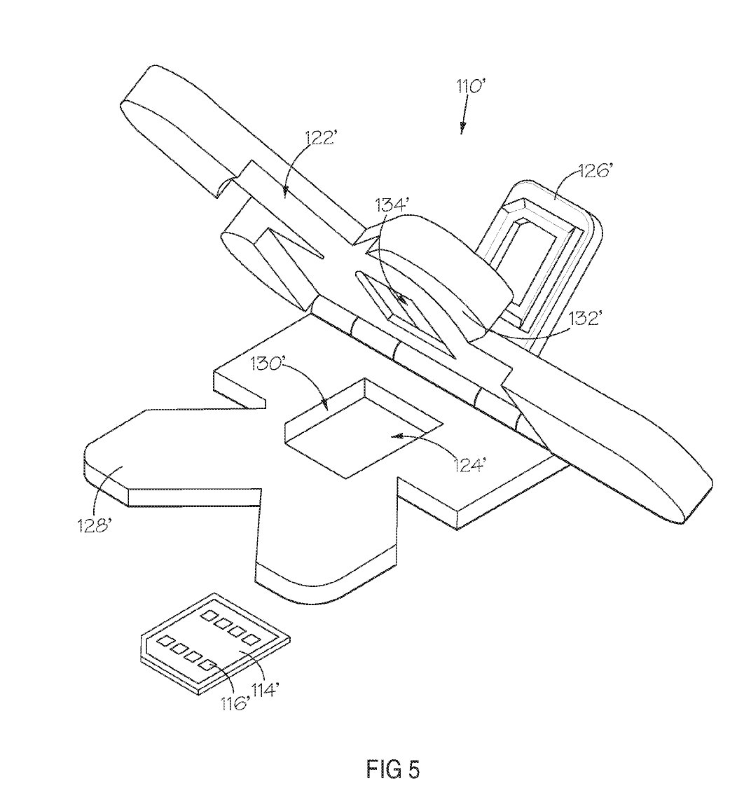

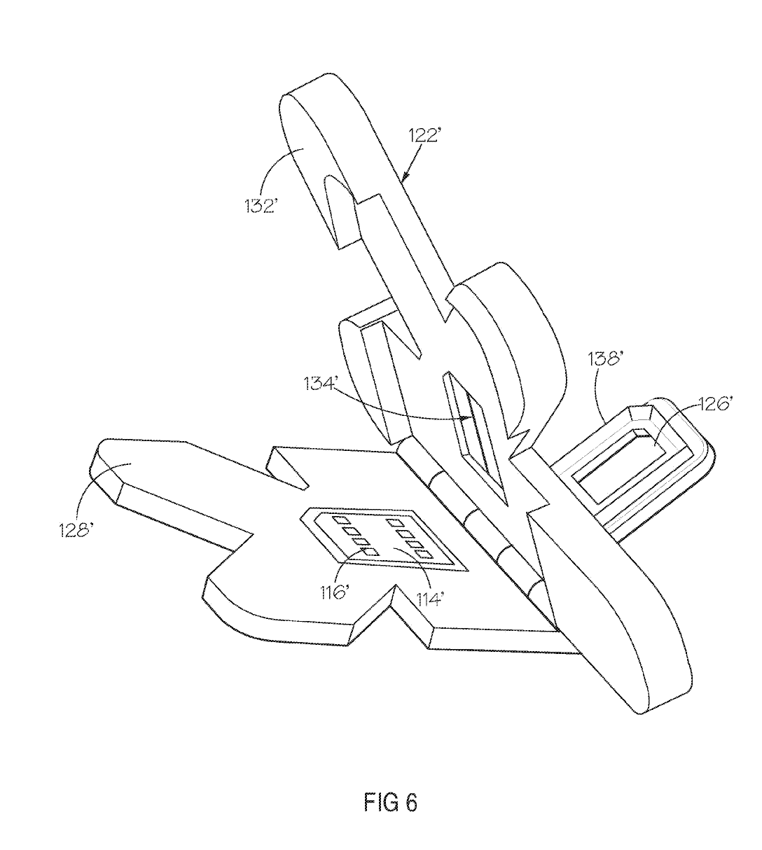

Turning now to FIGS. 2 to 4, and 5 and 6, two different embodiments of a SIM card applicator 110, 110′ are shown. However, there are substantial similarities between these two embodiments, and thus reference numerals in FIGS. 5 and 6 for similar components shown in FIGS. 2 to 4, are shown appended with a ′.

The SIM card applicator 110, 110′ enables a communications processing overlay 112 to be attached to a SIM card 114, 114′, the SIM card 114, 114′ comprising a plurality of SIM card pads 116, 116′.

In an embodiment, the overlay 112 comprises a communications processing portion 118 and a surrounding carrier portion 120.

The applicator 110, 110′ comprises a holder 122, 122′ to hold the overlay 112 in place, and a SIM receiving body 124, 124′ to receive the SIM card 114, 114′. The holder 122, 122′ and the SIM receiving body 124, 124′ are arranged to correctly align and secure the communications processing portion 118 of the overlay 112 and the SIM card pads 116, 116′ of the SIM card 114, 114′.

The applicator 110, 110′ further comprises a cutter element 126, 126′ that can be operated to cut out the communications processing portion 118 of the overlay 112 from the surrounding carrier portion 120. In broad terms, this results in the communications processing portion 118 of the overlay 112 being correctly aligned and secured to the SIM card pads 116, 116′, so as to define a modified SIM card for use in a mobile device.

In one version, the applicator 110, 110′ comprises a base plate 128, 128′ to define the SIM receiving body 124, 124′, the base plate 128, 128′ defining a SIM-shaped aperture 130, 130′ to accommodate the SIM card 114, 114′.

In this first version, the applicator 110, 110′ comprises a frame 132, 132′ that is pivotally movable relative to the base plate 128, 128′, via pin 133. The frame 132, 132′ defines a window 134, 134′ for accommodating the overlay 112, the window 134, 134′ and the aperture 130, 130′ in the base plate 128, 128′ being in alignment when the base plate 128, 128′ and the frame 132, 132′ are pivotally moved towards each other, so as to correctly align the communications processing portion 118 of the overlay 112 with the SIM card pads 116, 116′.

In an embodiment of this first version, the frame 132, 132′ comprises securing means, such as an adhesive film 136 (not shown in FIGS. 5 and 6, but it would be similar), for securing and correctly positioning, the overlay 112 to the frame 132, 132′, and for securing the overlay 112 to the SIM card 114, 114′ once the base plate 128, 128′ and the frame 132, 132′ have been pivotally moved towards each other and manually pressed together.

In an embodiment of this first version, the cutter element 126, 126′ includes a cutting formation 138, 138′ that is shaped to correspond to the interface 121 between the communications processing portion 118 and the surrounding carrier portion 120, to facilitate the separation of the communications processing portion 118 from the surrounding carrier portion 120.

Preferably, the interface 121 between the communications processing portion 118 and the surrounding carrier portion 120 is perforated, to further facilitate the separation of the communications processing portion 118 from the surrounding carrier portion 120.

In an embodiment of this first version, the cutter element 126, 126′ is pivotally movable, also via pin 133, relative to the frame 132, 132′ and the base plate 128, 128′. Alternatively, the cutter element 126, 126′ is a separate component, not attached to either the frame 132, 132′ or the base plate 128, 128′.

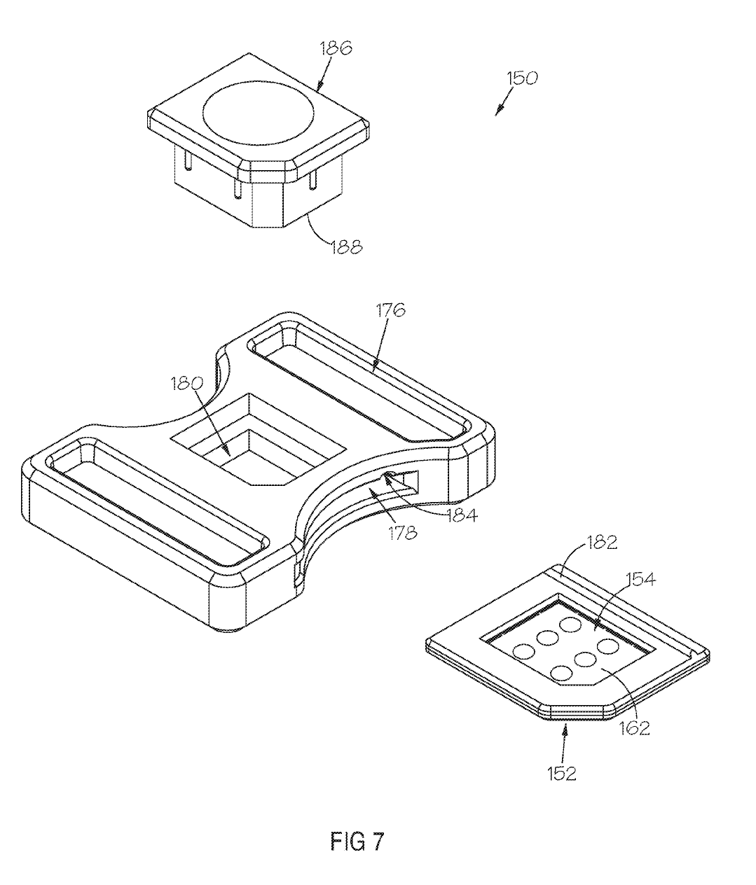

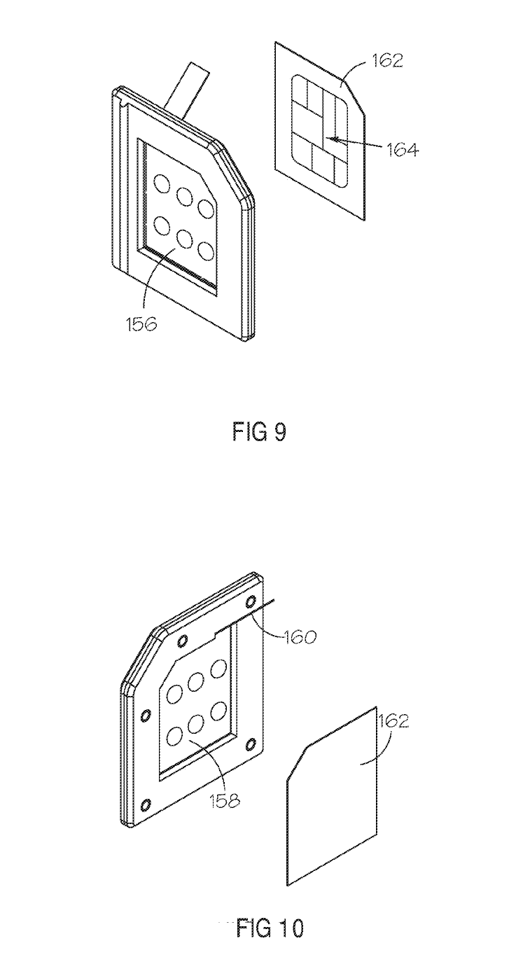

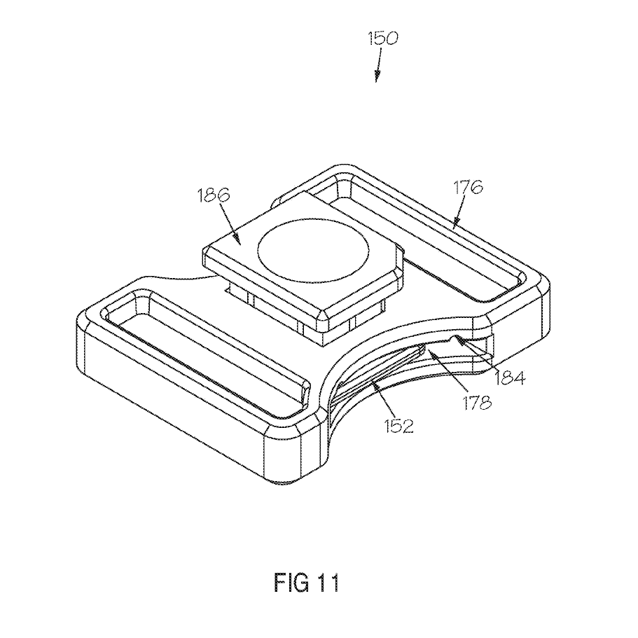

Turning now to FIGS. 7 to 11, a SIM card applicator 150 includes a frame arrangement 152 that integrally defines both the holder and the SIM receiving body, the frame arrangement 152 defining a central aperture 154.

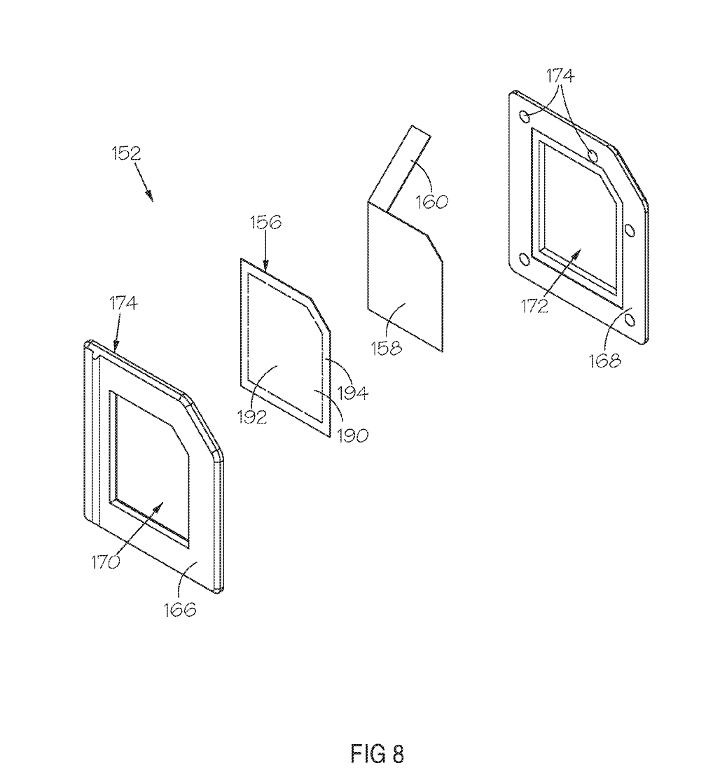

With reference to FIGS. 8 to 10 in particular, the overlay 156 is fitted with a removable covering film 158 (having a protruding tab 160), which upon removal, ensures the securing, and correct alignment, of the SIM card 162 to the overlay 156, the SIM card having pads 164.

In an embodiment, the frame arrangement 152 comprises a pair of plastic frame members 166, 168, each defining central apertures 170, 172, the frame members 166, 168 having securing members to secure the frame members 166, 168 together and to sandwich the overlay 156 and its associated removable covering film 158 between the frame members 166, 168.

In this alternate version, the applicator 150 comprises a jig body 176 having a slot 178 to receive the frame arrangement 152, the jig body 176 defining a central aperture 180 to register with the central aperture 170, 172 of the frame arrangement 152 when the frame arrangement 152 is inserted into the jig body 176.

Advantageously, the frame arrangement 152 and the jig body 176 include complementary guiding formations 182, 184 to facilitate the insertion of the frame arrangement 152 into the slot 178 of the jig body 176.

In an embodiment, the cutter element 186 includes a cutting formation 188 that is shaped to correspond to a perforated interface 190 between the communications processing portion 192 and the surrounding carrier portion 194, to facilitate the separation of the communications processing portion 192 from the surrounding carrier portion 194.

The cutter element 186 in this version is thus a separate component, which can be manually moved so that the cutting formation 188 is punched through the aligned apertures in the frame arrangement 152 and the jig body 176.

The present invention thus provides an easy to use SIM card applicator to correctly secure the overlay to the user's SIM card.

1. A SIM card applicator to enable a communications processing overlay to be attached to a SIM card, the SIM card comprising a plurality of SIM card pads, the overlay comprising a communications processing portion and overlay pads that allow for the communications processing portion to send/receive information to/from the SIM card, once attached, the applicator comprising:
a holder to releasably hold the overlay in place; and
a SIM receiving body to receive the SIM card, the holder and the SIM receiving body being arranged to correctly align and secure the communications processing portion of the overlay and the SIM card pads of the SIM card,
wherein the overlay can be removed or separated from the holder, thereby resulting in the communications processing portion of the overlay being correctly aligned and secured to the SIM card pads, so as to define a modified SIM card for use in a mobile device.

2. The SIM card applicator of claim 1, wherein the SIM receiving body comprises a credit card style holder with a cutout for accommodating the SIM card, with the cutout being aligned with the overlay, the applicator including an adaptor that can be placed within the cutout, the adaptor being arranged to accommodate a variety of different sizes of SIM cards.

3. (canceled)

4. The SIM card applicator of claim 1, wherein the holder comprises an adhesive protective film to which the overlay is releasably secured, the film also being releasably securable to a first side of the SIM receiving body.

5. The SIM card applicator of claim 1, wherein the applicator comprises a second adhesive protective film that is releasably securable to a second side of the SIM receiving body, so as to cover the overlay on the other side of the SIM receiving body.

6. The SIM card applicator of claim 1, wherein the overlay comprises a carrier portion that surrounds the communications processing portion, with the applicator including a cutter element to remove or separate the communications processing portion of the overlay from the surrounding carrier portion.

7. (canceled)

8. The SIM card applicator of claim 6, wherein the applicator comprises a base plate to define the SIM receiving body, the base plate defining an aperture to accommodate the SIM card, the applicator comprising a frame that is pivotally movable relative to the base plate, the frame defining a window for accommodating the overlay, the window and the aperture in the base plate being in alignment when the base plate and the frame are pivotally moved towards each other, so as to correctly align the communications processing portion of the overlay with the SIM card pads.

9. (canceled)

10. The SIM card applicator of claim 6, wherein the frame comprises securing means, such as an adhesive film, for securing, and correctly positioning, the overlay to the frame, and for securing the overlay to the SIM card once the base plate and the frame have been pivotally moved towards each other and pressed together.

11. The SIM card applicator of claim 6, wherein the cutter element includes a cutting formation that is shaped to correspond to the interface between the communications processing portion and the surrounding carrier portion, to facilitate the separation of the communications processing portion from the surrounding carrier portion.

12. The SIM card applicator of claim 6, wherein the interface between the communications processing portion and the surrounding carrier portion is weakened to further facilitate the separation of the communications processing portion from the surrounding carrier portion.

13. The SIM card applicator of claim 6, wherein the surrounding carrier portion comprises a tape to which the communications processing portion is releasably secured.

14. The SIM card applicator of claim 6, wherein the cutter element is either pivotally movable relative to the frame and the base plate or wherein the cutter element is a separate component, not attached to the frame and base plate.

15. (canceled)

16. The SIM card applicator of claim 6, wherein a frame arrangement is provided that integrally defines both the holder and the SIM receiving body, the frame arrangement defining a central aperture, wherein the applicator comprises a jig body having a slot to receive the frame arrangement, the jig body defining a central aperture to register with the central aperture of the frame arrangement when the frame arrangement is inserted into the jig body, with the frame arrangement and the jig body including complementary guiding formations to facilitate the insertion of the frame arrangement into the slot of the jig body.

17. (canceled)

18. The SIM card applicator of claim 16, wherein the overlay is fitted with a removable covering film, which upon removal, ensures the securing, and correct alignment, of the SIM card to the overlay, the frame arrangement comprising a pair of plastic frame members, each defining the central aperture, the frame members having securing members to secure the frame members together and to sandwich the overlay and its associated removable covering film between the frame members.

19. (canceled)

20. (canceled)

21. The SIM card applicator of claim 6, wherein the cutter element includes a cutting formation that is shaped to correspond to a perforated interface between the communications processing portion and the surrounding carrier portion, to facilitate the separation of the communications processing portion from the surrounding carrier portion.

22. The SIM card applicator of claim 21, wherein the cutter element is a separate component, which can be manually moved so that the cutting formation is punched through the aligned apertures in the frame arrangement and the jig body.

23. A method of applying a communications processing overlay to a SIM card, the SIM card comprising a plurality of SIM card pads and the overlay comprising a communications processing portion and overlay pads, the method comprising:
providing a holder to which the overlay is releasably secured;
aligning the overlay within a cutout defined in a SIM receiving body, the overlay having an adhesive on an exposed face;
locating the SIM card within the cutout;
firmly bonding the SIM card to the communications processing portion of the overlay; and
removing the bonded SIM card and overlay from the holder, thereby resulting in the communications processing portion of the overlay being correctly aligned and secured to the SIM card pads, so as to define a modified SIM card for use in a mobile device.

24. The method of claim 23, wherein the method comprises an initial step of removing a second protective film fitted to the other side of the SIM receiving body, so as to expose the adhesive, exposed face of the overlay.

25. A method of applying a communications processing overlay to a SIM card, the SIM card comprising a plurality of SIM card pads and the overlay comprising a communications processing portion and a surrounding carrier portion, the method comprising:
aligning and securing the communications processing portion of the overlay and the SIM card pads of the SIM card; and
removing the communications processing portion of the overlay from the surrounding carrier portion, thereby resulting in the communications processing portion of the overlay being correctly aligned and secured to the SIM card pads, so as to define a modified SIM card for use in a mobile device.

26. A frame arrangement for a SIM card applicator to enable a communications processing overlay to be attached to a SIM card, the overlay comprising a communications processing portion and a surrounding carrier portion, the frame arrangement comprising a frame body defining a central aperture, the overlay being positioned within the frame body, with the SIM card being housed within the central aperture of the frame body, the frame arrangement thus accommodating and correctly aligning the overlay and the SIM card.

27. The frame arrangement of claim 26, wherein the frame body comprises:
a pair of plastic frame members, each defining the central aperture, the overlay being positioned between the pair of plastic frame members; and
securing members to secure the frame members together, so as to sandwich the overlay between the frame members, with the SIM card being housed within the central apertures of one of the frame members,
wherein the overlay is fitted with a removable covering film, which upon removal, ensures the securing, and correct alignment, of the SIM card to the overlay within the frame arrangement.

28. (canceled)
